(19) United States
(12) Patent Application Publication
(10) Pub. No.: US 2023/0351354 A1
(43) Pub. Date: Nov. 2, 2023

(54) SYSTEM AND METHOD FOR METALOOK CARBON FOOTPRINT CALCULATIONS

(71) Applicant: More Dash Inc., Los Angeles, CA (US)

(72) Inventors: Daria Bektursunova, Los Angeles, CA (US); Olga Chernyshev, Puteaux (FR); Natalia Modenova, Los Angeles, CA (US)

(73) Assignee: More Dash Inc., Los Angeles, CA (US)

(21) Appl. No.: 17/732,865

(22) Filed: Apr. 29, 2022

(51) Int. Cl. G06Q 20/12; G06Q 20/40

(52) U.S. Cl. CPC G06Q 20/1235; G06Q 20/4014

(57) ABSTRACT

Disclosed is a method to calculate and display carbon emissions impact savings for a metalook or a transaction, by receiving from transaction data sources data items describing the transaction. Each transaction is associated with a user identifier (ID), metalook ID, and garment classification category associated with the metalook ID. For each transaction, a processor calculates, based on an amount of hours spent on garment creation and dressing associated with the transaction and the carbon emissions data for the garment classification category, a carbon emission impact saving associated with the transaction. Calculating carbon emissions impact savings for the transaction may include multiplying the hours on creation and dressing a metalook to a carbon emission multiplier, determined empirically, and subtracting this amount from a physical garment carbon footprint obtained from a database. The carbon emissions value may be displayed to a user.

### TECHNICAL FIELD

The present disclosure relates generally to digital garments and, more particularly, to determining of a carbon footprint associated with a digital garment.

### BACKGROUND

A carbon footprint is the total greenhouse gas (GHG) emissions caused by an individual, event, organization, service, place or product, expressed as carbon dioxide equivalent (CO2e). The carbon footprint of an individual, a nation, or an organization can be measured by undertaking a GHG emissions assessment, a life cycle assessment, or other calculative activities denoted as carbon accounting.

### SUMMARY

One embodiment provides a method to calculate and display the carbon emissions impact savings for a transaction associated with a metalook. In one implementation, a processor receives data items describing a transaction from transaction data sources. Each transaction is associated with a user identifier (ID) and metalook ID, as well as a physical garment category associated with the metalook. For the transaction, the processor receives carbon emissions impact savings data for a user associated with the user ID of the transaction, and calculates, based on an amount of time (e.g., hours) spent on metalook creation and dressing associated with the metalook ID of the transaction and the carbon emissions data for a physical garment category, a carbon emission impact saving associated with the transaction.

In some implementations, each data item may include a transaction amount, the user ID, the metalook ID, and/or other information. Calculating carbon emissions impact savings for the transaction may include multiplying the time for creation and dressing the metalook to an energy use multiplier (e.g., a carbon emission multiplier, determined empirically) and decreasing from a physical garment carbon footprint obtained from a database by calculated amount. The carbon emissions savings value may be displayed to the user in conjunction with the transaction.

One embodiment may display to the user a carbon emission impact savings related to one transaction, or as a summary of a total amount saved, and/or progress against a progress bar with milestones and rewards. In some implementations, once a user reaches a configurable pre-programmed amount of carbon emission impact savings (i.e., a milestone), the user receives a reward assigned to this milestone. Examples of rewards (not limited by the list) are access to an augmented reality (AR) metalook in a digital fashion mobile application (app), a discount on a customized metalook, free membership for a period of time to a digital fashion subscription, etc.

The disclosed systems and methods improve prior carbon footprint calculation technology and provide a technological solution that may be integrated into other services, which can help an average customer to understand an environmental impact from the fashion industry, and how the customer can decrease carbon emissions by changing their consumption habits. Various data sources (e.g., data sources that may be external to a digital fashion app) may be leveraged or accessed to receive or to provide carbon emission details.

Some embodiments may provide output to a user describing the carbon footprint impact savings for each transaction and the user’s overall carbon footprint impact savings for all transactions of the user. Some embodiments may follow the user’s personal savings progress bar, which may have pre-programmed milestones, where once a milestone is reached, a user gets a reward (e.g., a special metalook or a discount, as described).

One embodiment of the disclosure provides a method for determining a carbon emissions saving impact amount caused by a transaction, the method comprising: receiving, by a processor, data for a digital transaction, wherein the digital transaction corresponds to a purchase of digital metalook to be applied to an image, wherein the data for the digital transaction includes a user identifier (ID) for the digital transaction, a metalook ID for the digital transaction, and a garment classification category corresponding to the metalook ID; receiving, by the processor from a physical garment database, a physical carbon emissions amount corresponding to a physical garment based on the garment classification category associated with the digital transaction; receiving, by the processor from a metalook database, first carbon emissions data corresponding to an amount of time for design and rendering of a metalook corresponding to the metalook ID, wherein the metalook comprises a digitally modelled garment; receiving, by the processor from a metalook database, second carbon emissions data corresponding to an amount of time for dressing the metalook corresponding to the metalook ID to a subject included in the image corresponding to the digital transaction; determining, by the processor, a digital carbon emissions amount based on the first carbon emissions data and the second carbon emissions data; determining, by the processor, the carbon emission savings impact amount based on subtracting the digital carbon emissions amount from the physical carbon emissions amount; and transmitting, by the processor via an electronic network, the carbon emission savings impact amount to a computing device associated with the user ID for display on the computing device.

In some embodiment of the disclosure, the digital carbon emissions amount is further based on a first carbon emissions component associated with uploading the image corresponding to the digital transaction from the computing device associated with the user ID to a server computing device associated with the processor.

In some embodiment of the disclosure, the digital carbon emissions amount is further based on a second carbon emissions component associated with sending an email from server computing device associated with the processor to the computing device associated with the user ID, wherein the email includes a dressed image in which the subject included in the image corresponding to the digital transaction is dressed with the metalook corresponding to the metalook ID.

Some embodiment of the disclosure further comprise: determining, by the processor, a sum of carbon emission savings impact amounts associated with a plurality of digital transactions corresponding to the user ID; comparing, by the processor, the sum of carbon emission savings impact amounts to a set of milestones to determine which milestones in the set of milestones have been achieved, wherein a given milestone has been achieved in response to the sum of carbon emission savings impact amounts exceeding a threshold value associated with the given milestone; and transmitting, by the processor, information to the computing device associated with the user ID indicating which milestones in the set of milestones have been achieved.

In some embodiment of the disclosure, each milestone in the set of milestones corresponds to a reward for achieving the milestone. In some embodiment of the disclosure, the reward comprises one or more of access to an augmented reality (AR) metalook in a digital fashion mobile application, a discount on a future purchase of a metalook, or free membership for a period of time to a digital fashion subscription.

In some embodiment of the disclosure, the first carbon emissions data corresponding to the amount of time for design and rendering of the metalook is based on a multiplying the amount of time for design and rendering of the metalook by a first power consumption metric; and the second carbon emissions data corresponding to the amount of time for dressing the metalook corresponding to the metalook ID to the subject included in the image corresponding to the digital transaction is based on a multiplying the amount of time for dressing the metalook to the subject included in the image by a second power consumption metric, wherein the second power consumption metric is less than the first power consumption metric.

In some embodiment of the disclosure, the digital carbon emissions amount is further based on a geographical location corresponding to the computing device associated with the user ID.

### BRIEF DESCRIPTION OF THE DRAWING

The present disclosure may be best understood by reference to the following detailed description of the provided drawings.

FIG. 1 provides a system to implement a carbon footprint impact savings calculation methodology, according to embodiments of the present disclosure.

FIG. 2 shows flowchart of a method according to embodiments of the present disclosure.

FIG. 3 shows a sample user display showing milestones and a rewards progress bar, according to the embodiments of the present disclosure.

FIG. 4 is a block diagram of basic functional components for a computing device according to some aspects of the disclosure.

For the simplicity and clarity of the drawings, the elements shown in the figures have not been drawn accurately or to scale. The dimensions of some elements may be exaggerated and the designs simplified.

### DETAILED DESCRIPTION

As described, the present disclosure relates generally to digital garments and, more particularly, to determining a carbon footprint of a custom fitted photolook or metalook of digital garments. A carbon footprint of a digital interaction, in one implementation, is an amount of carbon dioxide or other greenhouse gas emissions associated with the digital interaction.

Digital fashion provides a solution for dressing three-dimensional (3D) fashion garments on a subject (e.g., a person) in an image and/or video, offering digital clothes to substitute physical garments, for example, to be worn on content for social media, gaming, or beyond. Instead of owning a physical garment, the customer pays for screenwear, i.e., 3D clothes that can be digitally dressed on the customer’s photos and videos.

A metalook is data structure that includes a digital garment (or digital look) dressed to a subject. Example metalooks include: a photolook where a digital garment is dressed on a subject in a photo, a videolook where a digital garment is dressed on a subject in a video, an augmented reality (AR) digital look, and/or a virtual reality (VR) digital look.

In some embodiments, a method to calculate the carbon footprint of a metalook is disclosed. This method can be used to determine the environmental impact savings from replacing physical garments by metalooks. There may be different databases with physical garment carbon emission data that can be used for comparison with the metalook carbon footprint. Thus, the carbon emission savings for using metalooks instead of physical garments, e.g., for influencer marketing campaign or social media photos, can be calculated. In an example use case, a customer can see their environmental impact savings in the customer’s profile.

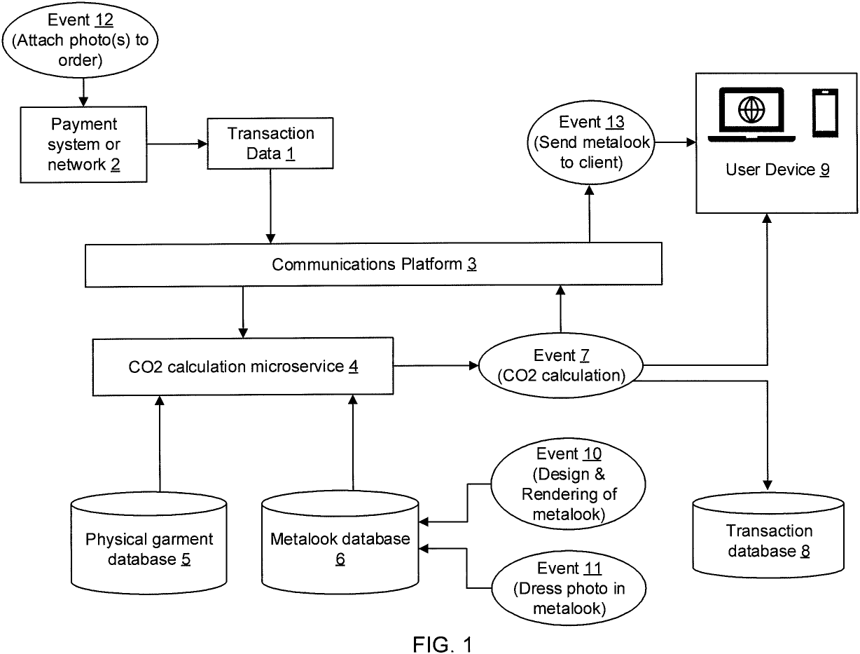

FIG. 1 shows a system to implement carbon footprint savings calculation methodology, according to embodiments of the present disclosure. Some of the various components of FIG. 1 may be separate computing devices, such as servers, or may be combined into one computing device. Some components of FIG. 1 may be included in other computing devices different from the computing devices shown in FIG. 1.

Transaction data 1 may be provided by a payment system or network 2 (e.g., credit or debit card network, internet payment services, etc.). Transaction data 1 may include, for a given transaction, a user ID, a user name, an email address, a transaction ID, a transaction amount, a metalook ID, a physical garment classification, one or more photos, among other data. In some embodiments, one or more photos in the transaction data 1 may be associated with an event 12, for example, by event ID.

Transaction data 1 and other data may be received by or communicated to a communications platform 3. Communications platform 3 may be implemented as a server computing device that includes one or more processors and one or more memories, where the one or more processors execute instructions stored in the one or more memories to implement the functionality of the communications platform 3. In one embodiment, each item of transaction data 1 is associated with a metalook ID and physical garment classification associated with the metalook ID.

A carbon footprint calculation microservice 4 may calculate values, such as carbon footprint of a metalook associated with a transaction, carbon emissions impact savings associated with a transaction and occurred because a user bought a metalook instead of a physical garment. The carbon footprint calculation microservice 4 may be implemented as software instructions executed by a processor on a computing device. In one embodiment, the carbon footprint calculation microservice 4 is executed by the communications platform 3. In other embodiments, the carbon footprint calculation microservice 4 is executed by another computing device besides the communications platform 3.

The carbon footprint calculation microservice 4 (CO2 calculation microservice 4) may take input from various sources, for example, a physical garment database 5 and/or a metalook database 6. The physical garment database 5 may include physical garment classification information and corresponding CO2 emission data corresponding to producing physical garments. An example of such a database is provided by SimaPro. Metalook database 6 includes data about metalooks, including metalook ID, time (e.g., hours) on of the creation of the metalook corresponding to the metalook ID, e.g., design and rendering, of the digital garment in the metalook, and time (e.g., hours) on dressing the digital garment to a subject in the metalook corresponding to the metalook ID. In one implementation, the data in the metalook database 6 may be provided by 3D designers and tailors that create (event 10) metalooks and dress (event 11) metalooks to subjects in images.

In some implementations, the carbon footprint calculation microservice 4 is configured to calculate a carbon footprint impact savings for a user, e.g. for a particular transaction and/or for a group of transactions for the user over a period of time. A carbon footprint calculation microservice 4 may calculate values, such as carbon footprint of a metalook associated with a transaction, or carbon emissions impact savings associated with a transaction and occurred because a user bought a metalook instead of a physical garment. Input to carbon footprint calculation microservice 4 may include transaction data 1 received via communications platform 3, physical garment database 5, and metalook database 6.

Carbon footprint calculation microservice 4 receives the transaction data 1, data from the physical garment database 5, and data from the metalook database 6, and executes CO2 footprint calculation (event 7). This calculation may perform carbon footprint savings impact calculation using the data collected in carbon footprint calculation microservice 4 for specific transaction data 1 mapping it with a corresponding user. The result of the calculation event 7, e.g., carbon footprint environmental savings associated the transaction, may be sent to the communication platform 3, including details regarding the relevant transaction 1 along with carbon footprint savings data typically relevant to a particular user.

The output of the CO2 calculation microservice 4 is based on the physical garment classification and metalook ID associated with the user ID and the transaction ID included in the transaction data 1. For example, the calculation event 7 of the CO2 calculation microservice 4 may calculate a carbon emission impact savings associated with each metalook in the transaction associated with a user. Based on garment classification (e.g., dress, jacket, coat, suit, jumpsuit, t-shirt, top, blouse, denim, bottoms, skirt, trench coat, shoes, bag, hat, accessories), CO2 calculation microservice 4 receives data from physical garment database 5 about a corresponding physical garment carbon footprint associated with the garment classification. Based on the metalook ID, CO2 calculation microserve 4 receives data from metalook database 6 on the hours of creation (event 10) and dressing (event 11) of the user’s photo. The data is matched together in CO2 calculation microservice 4 to perform calculation event 7, e.g., CO2 environmental impact savings calculations. The output of the calculation event 7 also can be stored in a transaction database 8, and can be shown to a user in the user’s account on a user device 9 for a separate transaction, or as a total of all transaction on the progress bar.

As mentioned, data from calculation event 7 of the carbon footprint impact savings calculations may be received by transaction database 8. Within the transaction database 8, each item of the transaction data 1 may be linked to carbon footprint data from physical garment database 5 and metalook database 6, as mapped by the CO2 calculation microservice 4. In one embodiment, each data item entered into transaction database 8 may include information describing the user ID, the transaction ID, transaction amount, carbon footprint emissions, and/or carbon footprint impact savings (versus physical garment).

The output of the calculation event 7 from CO2 calculation process microservice 4 may be sent via communication platform 3 (or CO2 calculation process microservice 4) to a user to be displayed via user device 9. The user device 9 provides access to a user account, which may provide information on transactions of the user, transaction amounts and carbon footprint impact savings for each transaction, and/or the total carbon footprint impact savings for all transactions of the user.

The communication platform 3 may send, via event 13, a result (i.e., a custom fitted metalook) to the user to be displayed via the user device 9 or any other device.

Carbon emission impact savings from using a metalook instead of an associated physical garment can be calculated based on the above disclosed methodology. When analyzing the impact of the digital garment, four (4) phases are taken into consideration: (1) design or production phase (i.e., designing a digital garment through software and rendering, including uploading a digital garment from a software), (2) order (i.e., attaching an image to the order on a website or in an app), (3) “dressing” (i.e., placement of digital garment on the image), and (4) in-use (e.g., sending a garment to a client via email).
1. Production: Design & Rendering
2. Order: Attaching a photo to the order on the website or in app
3. Dressing: Placement of digital item on picture
4. In-use: Sending a digital garment to client via email

In one embodiments, to calculate the carbon footprint a metalook, the disclosed methodology takes into consideration an amount of electricity consumption of digital devices during each phase and converts the amount of electricity consumption into an equivalent in kilograms (kg) of CO2 (kgCO2eq).

A digital carbon footprint is greatly influenced by how much time a user spends on electronic devices, on the type of the device (e.g., configuration of a computer, graphics processing unit (GPU), tablet, smartphone, etc.), and where a user is located. The carbon emissions stemming from electricity usage are dependent on how the electricity is produced in each country (e.g., hydropower, nuclear, fossils, wind, and/or solar, for example).

In some implementations, the (1) Production and (3) Dressing phases are performed on desktop computers with large monitors. In some implementations, working on laptops takes much more time for digital design, especially rendering, and also decreases the quality of the output, thus designers often use desktop computers.

Below is an example implementation followed by designers during the (1) Production phase:
1. Creating patterns in Clo3D, Marvelous Designer, Browzwear, Blender, or other software (e.g., 3D sewing software).
2. Simulation of patterns (e.g., fabric) on an avatar.
3. Editing a shape of the patterns.
4. Editing proportions of the patterns to fit a body shape of the avatar.
5. Creating textures in Photoshop, Substance Designer, Substance Alchemist, Zbrush, Blender, Cinema4D, or other software.
6. Creating/baking maps (e.g., normal map, displacement map, roughness map) using Photoshop or Substance Alchemist, for example.
7. Creating different types of fabric, and adjusting their physics and materiality.
8. Creating an animation in Cinema 4D, Blender, or the other software, and applying the animation to the avatar.
8. Rendering of at least three looks (e.g., front, back and ¾ angel side look) of a final version.

In addition to the steps described above, designers may render work-in-progress looks to see how the looks might render in the final version.

Below are example steps followed by digital designers and/or digital tailors during the (3) Dressing phase:
1. Open PureRef, move a client’s photo used for dressing on a software page, make the photo semi-transparent and fix properties of the photo.
2. Open 3D sewing software with a semi-transparent photo and adjust the pose of the avatar in 3D sewing software to reflect the posture of the client on the photo.
3. Adjust lighting in the 3D sewing software.
4. Render the digital garment on a transparent background.
5. Put the render of the digital garment on the client’s photo in Photoshop, for example.
6. Edit the final image (e.g., add shadows, contrast, coloring, etc.)

In various embodiments, the (2) Order phrase and (4) In-use phase can be done on any type of electronic device (e.g., laptop, desktop, tablet, mobile device, smart watch, etc.). It is contemplated that in many implementations, but not necessarily all, the (2) Order phase and (4) In-use phase are less computationally expensive and would be done on smaller-screen devices, and thus would therefore use less electricity and generate less CO2 than the (1) Production and (3) Dressing phases.

### Computer Configurations

There is a lot of data on energy consumption of gaming desktop computers and very little data on energy consumption of desktop computers for graphic works. However, there is data that graphic works can be accomplished with a gaming computer. For example, an average gaming computer has all the components inside that are commonly used for graphics design, regardless of the graphics design program being used.

To generate a graphics and/or 3D design, the designer commonly uses a computer with a stronger CPU (Central Processing Unit) and more RAM (Random-Access Memory) than a pure gaming rig or computer. A stronger CPU will decrease rendering times and more RAM is helpful when rendering high-definition (HD) images or videos (for example, Adobe Photoshop tends to use a lot of RAM at high usage). For gaming, the user does not typically need much RAM or CPU; however, the GPU (Graphics Processing Unit) must be powerful. A GPU typically consumes 3 to 5 times more energy than a CPU. That being said, an average gaming computer can be used as a benchmark in terms of energy consumption for an above-average graphics/3D design computer.

### Power Consumption

When it comes to a typical desktop computer, in some implementations, the average number of watts used range from 60-300 watts per hour. For a mid-range gaming computer, these numbers go to 300-500 watts per hour.

In one implementation, data on power consumption of desktop computers is collected, including gaming computers, in the following table:

TABLE 1

Power Consumption for different types of computers

| | |
|---|---|
| Type of a computer | Power Consumption, watts per hour |
| Average desktop computer | 60 - 300 |
| Average desktop computer | 60 - 300 |
| Average gaming computer | 300 - 500 |
| Minimal capacity gaming computer | 160 - 340 |
| Mid-range gaming computer | 290 at full load |

Analyzing the steps performed during the (1) Production phase and the software involved, it is understood that a strong RAM and CPU and average GPU may be used. This configuration corresponds to mid-range gaming PCs working in a full capacity.

Taking into account the data from Table 1 on power consumption of different types of computers, the highest power consumption for an average desktop computer (i.e., up to 300 watts per hour) and the highest range of the power consumption for a gaming computer (i.e., up to 290, 340, 500 watts per hour) was taken for the calculations. In one implementation, the methodology takes a mean amount among 290, 300, 300, 340, and 500 watts per hour. This amount equals 346 watts per hour.

Thus, the energy consumption of the (1) Production phase, i.e., the energy consumption for one hour of creating and rendering a digital garment is 346 Wh (0.346 kWh).

To convert the energy consumption into CO2 emission, some embodiments consider where the energy comes from. In this methodology, some embodiments use the following conversion indexes (EK) for US, Europe, and an average of US and Europe energy use if we do not know the location of the designer. This table is not intended to be exclusive and may be extended with other countries conversion indexes, if needed.

TABLE 2

Energy to GHG emission conversion indexes

| Energy Country Origin | kgCO2eq per kWh, (EK) |
|---|---|
| US | 0.427 |
| EU | 0.275 |
| Average US+EU | 0.3510 |

In one example implementation, a carbon footprint of creating and rendering a digital garment (i.e., (1) Production phase) for one hour working on the PC: 0.346 kWh × EK kgCO2eq/kWh, kgCO2eq

Analyzing the steps performed during the (3) Dressing phase, designers confirmed that they use more Photoshop than Clo3D software. Photoshop requires less power from the computer than Clo3D. That is why the power consumption of the computing device used during the Dressing phase may be lower than one of the Production phase.

In one disclosed methodology, the average power consumption between 160 watts per hour (the minimal power consumption for a minimal capacity gaming computer, Table 1) and 300 watts per hour (the minimal power consumption for an average gaming computer, Table 1) was used for the Dressing phase. This amount equals 230 watts per hour (i.e., (160+300)/2 = 230).

Thus, the energy consumption of the (3) Dressing phase, i.e., the energy consumption for one hour of dressing a digital garment on a client’s photo is 230 Wh (0.230 kWh).

In one example implementation, a carbon footprint of (3) Dressing phase for one hour working on the PC is: 0.230 kWh × EK kgCO2eq/kWh, kgCO2eq

The (4) In-use phase includes, for example, sending a digitized look to a client. This can be an email with an attached photo. Publicly available research has demonstrated that sending an email with an attachment emits approximately 0.050 kg CO2eq per email.

To track all carbon emission associated with the production and get the garment “ready-to-wear,” which is in case of metalook delivering a dressed photo to a client, one embodiment considers the carbon emission from the process when a client uploads a photo to the order on the website, i.e., the (2) Order phase. According to a publicly available report titled “The environmental costs of being selfiesh” by CORE Doing Economics, carbon emission of uploading a single photo to Instagram or a website server is 0.005 kg CO2eq.

In some embodiments, a carbon footprint from an online financial transaction and/or carbon footprint associated with cloud-based data storage may be added to the formula of the carbon footprint of a digital garment. For the formula, one embodiment uses “F” kg CO2eq to represent the carbon footprint from the online financial transaction and/or carbon footprint associated with cloud-based data storage amount. For the transaction paid by a credit or debit card, or another method using traditional currency (not crypto currency), at the moment, there are not enough data on CO2 emission of one transaction or the amount of CO2 emission is relatively small, that we assume it is zero.

In one embodiment, cryptocurrency can be used for paying for the transaction. In this case, CO2 emission of the financial transaction, “F” kg CO2eq, may be needed to be calculated and considered. A carbon footprint of financial transaction F might be calculated with the open source calculator for each individual transaction using open source calculator Carbon.fyi from Offsetra.

Thus, in one implementation, the carbon footprint of a digital garment from design to delivery to a client can be calculated as follows:

$$\begin{matrix}\text{Carbon = 0} \text{.346 kWh} \times \text{EK kgCO2eq/kWh} \times \left[\text{hours spent on Production}\right] \\ \text{footprint +} \\ \text{of one 0} \text{.230 kWh} \times \text{EK kgCO2eq/kWh} \times \left[\text{hours spent on Dressing}\right] \\ \text{digital +} \\ \text{garment 0} \text{.050 (email)} + 0.005 \text{} \text{(upload) + (financial)}\end{matrix}$$

In some implementation, if the garment will be sold to multiple clients (N), then the calculations of the carbon footprint can be as calculated as follows:

$$\begin{matrix}\text{Carbon = 0} \text{.346 kWh} \times \text{EK kgCO2eq/kWh} \times \left[\text{hours spent on Production}\right] \\ \text{footprint of +} \\ \text{digital 0} \text{.230 kWh} \times \text{EK kgCO2eq/kWh} \times \left[\text{hours spent on Dressing}\right] \times \text{N} \\ \text{garment +} \\ \text{sold to N 0} \text{.050} \left(\text{email}\right) \times \text{N} \\ \text{clients +} \\ \text{0} \text{.005} \left(\text{upload}\right) \times \text{N} \\ \text{+} \\ \text{F} \left(\text{financial}\right) \times \text{N} \\ \end{matrix}$$

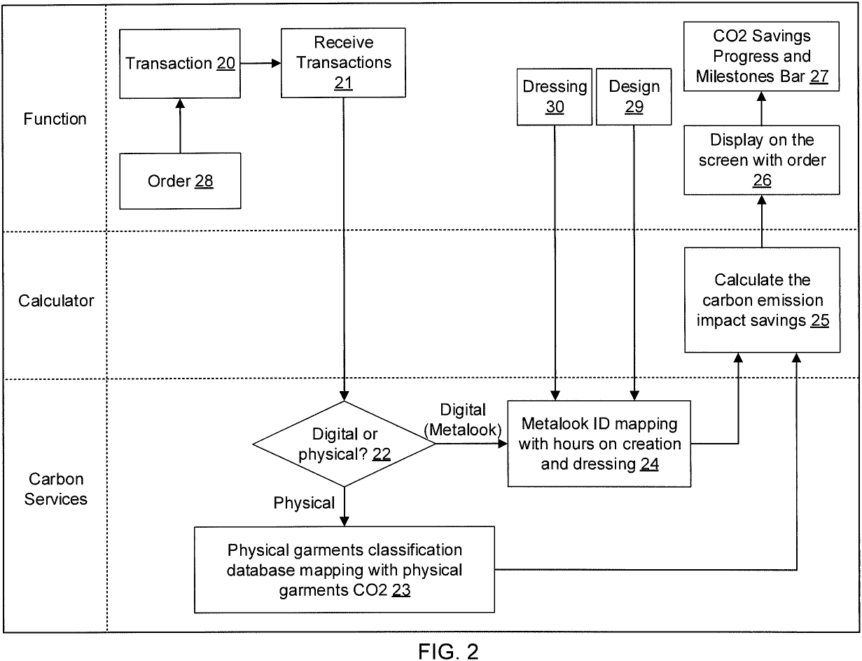

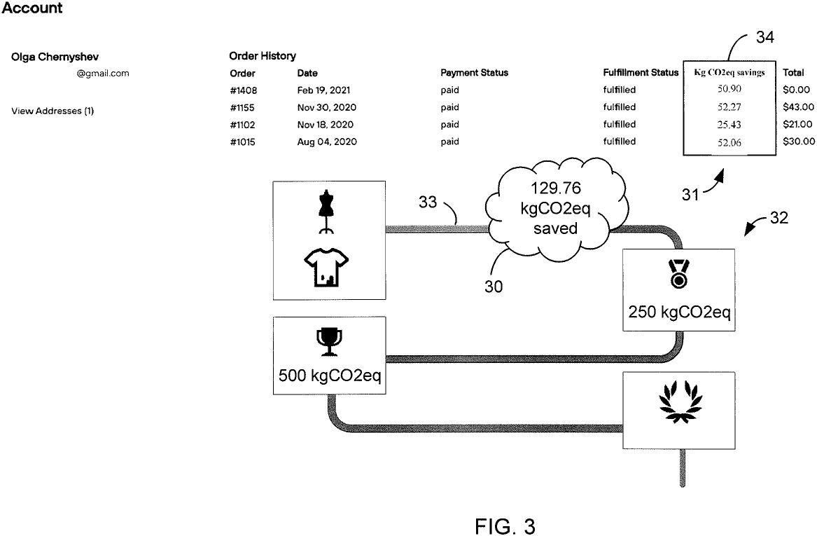

FIG. 2 shows a flowchart of a method according to embodiments of the present disclosure. The operations of FIG. 2 may be performed by the systems shown in FIG. 1 and FIG. 3, but other systems may be used. In FIG. 2, a transaction 20 may take place. For example, a user may place an order 28 to purchase a metalook using an electronic payment, such as credit card, debit card, or any other payment method. In operation 21, a computer system may receive from a transaction data source transaction data describing the transaction 20. In one embodiment, each transaction is associated with a user ID, metalook ID, and physical garment classification associated with the metalook ID.

For each transaction, a computer system may receive carbon emission data for an associated physical garment database 23 and hours spent on metalook creation and dressing from a metalook database 24. For example, in operation 22, a request from databases 23 and 24 is performed. Once the information is gathered from the databases 23 and 24, the data is received by operation 25. Operation 25 performs a carbon footprint impact savings calculation, which occurs because the user bought a metalook instead of physical garment. In operation 26, carbon emissions impact savings for the transaction 20 may be displayed to the user. In operation 27, total carbon emissions impact savings among all of the user’s transactions may be displayed on a process bar with milestones and rewards indications depending on the occurred carbon emissions impact savings. Other or different operations may be performed.

In some embodiments, a carbon footprint impact savings progress bar may display information to the user to make the user aware of their carbon footprint impact savings and also the progress until the next milestone, e.g., towards a reward. For example, an embodiment may include a reward program to help a user to switch to metalooks instead of physical garments.

One example use case is a new visual to be used for social media. A user can decrease their carbon footprint by showing their total carbon footprint impact savings by choosing to generate a new visual with a digital garment versus a new visual with a physical garment. Getting a reward (e.g., special Augmented Reality (AR) look, a discount for a next purchase, etc.) may encourage users to make more conscious choices in the type of garment they purchase and educate the users on the advantages of metalooks over physical garments in terms of carbon footprint impact savings. Integrating a reward program as a part of the disclosed embodiments gives to the user a gaming experience - i.e., collect points (for example, carbon footprint impact savings in kg CO2 eq), which makes the whole process of purchasing and tracking the impact more interesting and exciting for the users.

FIG. 3 depicts a sample user display showing a user account page together with a visual design of a reward program. The user display includes a progress bar 30 and a line 33 as visual indication of a status of the user’s progress along the progress bar 30. An information board 31 is included in the user display representing the user’s total carbon footprint savings impact cumulated among all transactions. A carbon footprint impact savings may be calculated and displayed for each separate transaction in information board 31. An example of such a display is shown in column 34. Also shown in the user display are milestones 32. Once achieved, each milestone 32 will open a reward (e.g., free special metalook, access to a free AR look, time limited free subscription to the app with AR looks, etc.), which the user can collect. The more carbon footprint is saved, the bigger the reward for the user.

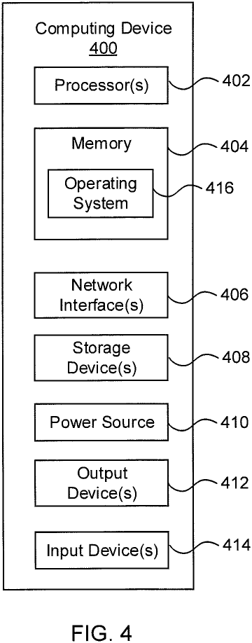

FIG. 4 is a block diagram of basic functional components for a computing device 400 according to some aspects of the disclosure. The computing device 400 may implement the methods and techniques disclosed herein, such as those performed by the communication platform 3, and the CO2 calculation microservice 4, user device 9, etc. In the illustrated embodiment of FIG. 4, the computing device 400 includes one or more processors 402, memory 404, network interfaces 406, storage devices 408, power source 410, one or more output devices 412, one or more input devices 414, and software modules - e.g., an operating system 416 -stored in memory 404. The software modules are provided as being included in memory 404, but in certain embodiments, the software modules are included in storage devices 408 or a combination of memory 404 and storage devices 408. Each of the components including the processor 402, memory 404, network interfaces 406, storage devices 408, power source 410, output devices 412, input devices 414, and operating system 416 are interconnected physically, communicatively, and/or operatively for inter-component communications.

In various embodiments, one or more of the device 102, hub device 104, management computing device 110, and server 108 shown in FIG. 1 may be implemented as a computing device 400 as shown in FIG. 4.

As illustrated, processor 402 is configured to implement functionality and/or process instructions for execution within computing device 400. For example, processor 402 executes instructions stored in memory 404 or instructions stored on a storage device 408. Memory 404, which may be a non-transient, computer-readable storage medium, is configured to store information within computing device 400 during operation. In some embodiments, memory 404 includes a temporary memory, an area for information not to be maintained when the computing device 400 is turned off. Examples of such temporary memory include volatile memories such as random access memories (RAM), dynamic random access memories (DRAM), and static random access memories (SRAM). Memory 404 also maintains program instructions for execution by the processor 402.

Storage device 408 also includes one or more non-transient computer-readable storage media. The storage device 408 is generally configured to store larger amounts of information than memory 404. The storage device 408 may further be configured for long-term storage of information. In some embodiments, the storage device 408 includes non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

Computing device 400 uses network interface 406 to communicate with external devices, databases, or servers via one or more networks 106 (see FIG. 1), and other types of networks through which a communication with the computing device 400 may be established. Network interface 406 may be a network interface card, such as an Ethernet card, an optical transceiver, a radio frequency transceiver, or any other type of device that can send and receive information. Other non-limiting examples of network interfaces include Bluetooth®, 3G and Wi-Fi radios in client computing devices, ZigBee, Z-Wave, and Universal Serial Bus (USB), among others.

Computing device 400 includes one or more power sources 410 to provide power to the device. Non-limiting examples of power source 410 include single-use power sources, rechargeable power sources, and/or power sources developed from nickel-cadmium, lithium-ion, or other suitable material.

One or more output devices 412 are also included in computing device 400. Output devices 412 are configured to provide output to a user using tactile, audio, and/or video stimuli. Output device 412 may include a display screen (part of the presence-sensitive screen), a sound card, a video graphics adapter card, or any other type of device for converting a signal into an appropriate form understandable to humans or machines. Additional examples of output device 412 include a speaker such as headphones, a cathode ray tube (CRT) monitor, a liquid crystal display (LCD), or any other type of device that can generate intelligible output to a user.

The computing device 400 includes one or more input devices 414. Input devices 414 are configured to receive input from a user or a surrounding environment of the user through tactile, audio, and/or video feedback. Non-limiting examples of input device 414 include a photo and video camera, presence-sensitive screen, a mouse, a keyboard, a voice responsive system, microphone or any other type of input device. In some examples, a presence-sensitive screen includes a touch-sensitive screen.

The computing device 400 includes an operating system 416. The operating system 416 controls operations of the components of the computing device 400. For example, the operating system 416 facilitates the interaction of the processor(s) 402, memory 404, network interface 406, storage device(s) 408, input device 414, output device 412, and power source 410.

Descriptions of embodiment of the disclosure on the present application are provided by examples and are not intended to limit the scope of the disclosure. The described embodiments comprise different features, not all of which are required in all environments. Some elements described using one embodiment may be combined with features or elements described in other embodiments. The scope of the disclosure is limited only by the claims.

While certain features of the disclosure have been illustrated and described herein, many modifications, substitutions, changes may occurred. It is, therefore, to be understood that the appended claims are intended to cover all such modifications and changes as fall within the spirit of the disclosure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosure (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method for determining a carbon emissions saving impact amount caused by a transaction, the method comprising:
receiving, by a processor, data for a digital transaction, wherein the digital transaction corresponds to a purchase of digital metalook to be applied to an image, wherein the data for the digital transaction includes a user identifier (ID) for the digital transaction, a metalook ID for the digital transaction, and a garment classification category corresponding to the metalook ID;
receiving, by the processor from a physical garment database, a physical carbon emissions amount corresponding to a physical garment based on the garment classification category associated with the digital transaction;
receiving, by the processor from a metalook database, first carbon emissions data corresponding to an amount of time for design and rendering of a metalook corresponding to the metalook ID, wherein the metalook comprises a digitally modelled garment;
receiving, by the processor from a metalook database, second carbon emissions data corresponding to an amount of time for dressing the metalook corresponding to the metalook ID to a subject included in the image corresponding to the digital transaction;
determining, by the processor, a digital carbon emissions amount based on the first carbon emissions data and the second carbon emissions data;
determining, by the processor, the carbon emission savings impact amount based on subtracting the digital carbon emissions amount from the physical carbon emissions amount; and
transmitting, by the processor via an electronic network, the carbon emission savings impact amount to a computing device associated with the user ID for display on the computing device.

2. The method of claim 1, wherein the digital carbon emissions amount is further based on a first carbon emissions component associated with uploading the image corresponding to the digital transaction from the computing device associated with the user ID to a server computing device associated with the processor.

3. The method of claim 2, wherein the digital carbon emissions amount is further based on a second carbon emissions component associated with sending an email from server computing device associated with the processor to the computing device associated with the user ID, wherein the email includes a dressed image in which the subject included in the image corresponding to the digital transaction is dressed with the metalook corresponding to the metalook ID.

4. The method of claim 1, further comprising:
determining, by the processor, a sum of carbon emission savings impact amounts associated with a plurality of digital transactions corresponding to the user ID;
comparing, by the processor, the sum of carbon emission savings impact amounts to a set of milestones to determine which milestones in the set of milestones have been achieved, wherein a given milestone has been achieved in response to the sum of carbon emission savings impact amounts exceeding a threshold value associated with the given milestone; and
transmitting, by the processor, information to the computing device associated with the user ID indicating which milestones in the set of milestones have been achieved.

5. The method of claim 4, wherein each milestone in the set of milestones corresponds to a reward for achieving the milestone.

6. The method of claim 5, wherein the reward comprises one or more of access to an augmented reality (AR) metalook in a digital fashion mobile application, a discount on a future purchase of a metalook, or free membership for a period of time to a digital fashion subscription.

7. The method of claim 1,
wherein the first carbon emissions data corresponding to the amount of time for design and rendering of the metalook is based on a multiplying the amount of time for design and rendering of the metalook by a first power consumption metric; and
wherein the second carbon emissions data corresponding to the amount of time for dressing the metalook corresponding to the metalook ID to the subject included in the image corresponding to the digital transaction is based on a multiplying the amount of time for dressing the metalook to the subject included in the image by a second power consumption metric,
wherein the second power consumption metric is less than the first power consumption metric.

8. The method of claim 1, wherein the digital carbon emissions amount is further based on a geographical location corresponding to the computing device associated with the user ID.

9. A non-transitory computer-readable storage medium storing instructions that, when executed by a processor, cause the processor to determine a carbon emissions saving impact amount by performing operations comprising:
receiving data for a digital transaction, wherein the digital transaction corresponds to a purchase of digital metalook to be applied to an image, wherein the data for the digital transaction includes a user identifier (ID) for the digital transaction, a metalook ID for the digital transaction, and a garment classification category corresponding to the metalook ID;
receiving, from a physical garment database, a physical carbon emissions amount corresponding to a physical garment based on the garment classification category associated with the digital transaction;
receiving, from a metalook database, first carbon emissions data corresponding to an amount of time for design and rendering of a metalook corresponding to the metalook ID, wherein the metalook comprises a digitally modelled garment;
receiving, from a metalook database, second carbon emissions data corresponding to an amount of time for dressing the metalook corresponding to the metalook ID to a subject included in the image corresponding to the digital transaction;
determining a digital carbon emissions amount based on the first carbon emissions data and the second carbon emissions data;
determining the carbon emission savings impact amount based on subtracting the digital carbon emissions amount from the physical carbon emissions amount; and
transmitting, via an electronic network, the carbon emission savings impact amount to a computing device associated with the user ID for display on the computing device.

10. The computer-readable storage medium of claim 9, wherein the digital carbon emissions amount is further based on a first carbon emissions component associated with uploading the image corresponding to the digital transaction from the computing device associated with the user ID to a server computing device associated with the processor.

11. The computer-readable storage medium of claim 10, wherein the digital carbon emissions amount is further based on a second carbon emissions component associated with sending an email from server computing device associated with the processor to the computing device associated with the user ID, wherein the email includes a dressed image in which the subject included in the image corresponding to the digital transaction is dressed with the metalook corresponding to the metalook ID.

12. The computer-readable storage medium of claim 9, the operations further comprising:
determining a sum of carbon emission savings impact amounts associated with a plurality of digital transactions corresponding to the user ID;
comparing the sum of carbon emission savings impact amounts to a set of milestones to determine which milestones in the set of milestones have been achieved, wherein a given milestone has been achieved in response to the sum of carbon emission savings impact amounts exceeding a threshold value associated with the given milestone; and
transmitting information to the computing device associated with the user ID indicating which milestones in the set of milestones have been achieved.

13. The computer-readable storage medium of claim 12, wherein each milestone in the set of milestones corresponds to a reward for achieving the milestone.

14. The computer-readable storage medium of claim 13, wherein the reward comprises one or more of access to an augmented reality (AR) metalook in a digital fashion mobile application, a discount on a future purchase of a metalook, or free membership for a period of time to a digital fashion subscription.

15. The computer-readable storage medium of claim 9,
wherein the first carbon emissions data corresponding to the amount of time for design and rendering of the metalook is based on a multiplying the amount of time for design and rendering of the metalook by a first power consumption metric; and
wherein the second carbon emissions data corresponding to the amount of time for dressing the metalook corresponding to the metalook ID to the subject included in the image corresponding to the digital transaction is based on a multiplying the amount of time for dressing the metalook to the subject included in the image by a second power consumption metric,
wherein the second power consumption metric is less than the first power consumption metric.

16. The computer-readable storage medium of claim 9, wherein the digital carbon emissions amount is further based on a geographical location corresponding to the computing device associated with the user ID.

17. A device for determining a carbon emissions saving impact amount, the device comprising:
a memory storing instructions; and
a processor configured to execute the instructions to cause the device to:
receive data for a digital transaction, wherein the digital transaction corresponds to a purchase of digital metalook to be applied to an image, wherein the data for the digital transaction includes a user identifier (ID) for the digital transaction, a metalook ID for the digital transaction, and a garment classification category corresponding to the metalook ID;
receive, from a physical garment database, a physical carbon emissions amount corresponding to a physical garment based on the garment classification category associated with the digital transaction;
receive, from a metalook database, first carbon emissions data corresponding to an amount of time for design and rendering of a metalook corresponding to the metalook ID, wherein the metalook comprises a digitally modelled garment;
receive, from a metalook database, second carbon emissions data corresponding to an amount of time for dressing the metalook corresponding to the metalook ID to a subject included in the image corresponding to the digital transaction;
determine a digital carbon emissions amount based on the first carbon emissions data and the second carbon emissions data;
determine the carbon emission savings impact amount based on subtracting the digital carbon emissions amount from the physical carbon emissions amount; and
transmit, via an electronic network, the carbon emission savings impact amount to a computing device associated with the user ID for display on the computing device.

18. The device of claim 17, wherein the digital carbon emissions amount is further based on:
a first carbon emissions component associated with uploading the image corresponding to the digital transaction from the computing device associated with the user ID to a server computing device associated with the processor; and
a second carbon emissions component associated with sending an email from server computing device associated with the processor to the computing device associated with the user ID, wherein the email includes a dressed image in which the subject included in the image corresponding to the digital transaction is dressed with the metalook corresponding to the metalook ID.

19. The device of claim 17, wherein the processor executing the instructions further causes the device to:
determine a sum of carbon emission savings impact amounts associated with a plurality of digital transactions corresponding to the user ID;
compare the sum of carbon emission savings impact amounts to a set of milestones to determine which milestones in the set of milestones have been achieved, wherein a given milestone has been achieved in response to the sum of carbon emission savings impact amounts exceeding a threshold value associated with the given milestone; and
transmit information to the computing device associated with the user ID indicating which milestones in the set of milestones have been achieved, wherein each milestone in the set of milestones corresponds to a reward for achieving the milestone.

20. The device of claim 17,
wherein the first carbon emissions data corresponding to the amount of time for design and rendering of the metalook is based on a multiplying the amount of time for design and rendering of the metalook by a first power consumption metric; and
wherein the second carbon emissions data corresponding to the amount of time for dressing the metalook corresponding to the metalook ID to the subject included in the image corresponding to the digital transaction is based on a multiplying the amount of time for dressing the metalook to the subject included in the image by a second power consumption metric,
wherein the second power consumption metric is less than the first power consumption metric.
